(19) United States
(12) Patent Application Publication
(10) Pub. No.: US 2008/0255840 A1
(43) Pub. Date: Oct. 16, 2008

(54) Video Nametags

(75) Inventor: Ross G. Cutler, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/735,674

(22) Filed: Apr. 16, 2007

(51) Int. Cl. G10L 15/00

(52) U.S. Cl. 704/246

(57) ABSTRACT

Video nametags allow automatic identification of people speaking in a video. A video nametag is associated with a person who is participating in a video, such as a video conference scenario or recorded meeting. The video nametag includes one or more sensors that detect when the person is speaking. The video nametag transmits information to a video conferencing system that provides an indicator on a display of the video that identifies the speaker. The system may also automatically format the display of the video to concentrate on the person when the person is speaking. The video nametag can also capture the wearer's audio and transmit it wirelessly to be used for the conference audio send signal.

### BACKGROUND

A major issue in video conferencing is for local participants to know who is on the remote side and who is speaking. Video may help local participants to visually recognize the remote people, but for meetings where the remote and local participants don't know each other, that is not the case. In face-to-face meetings, nametags are often used so people know each other's names. However, nametags are not typically readable over a video conference because of the camera resolution.

Recorded meetings can be indexed by who is speaking, which is very useful for playing back the meeting (e.g., play only the parts where Bill spoke). However this indexing requires very accurate speaker detection and speaker identification, which is very difficult to do.

### SUMMARY

The following presents a simplified summary of the disclosure in order to provide a basic understanding to the reader. This summary is not an extensive overview of the disclosure and it does not identify key/critical elements of the subject matter or delineate the scope of the claimed subject matter. Its sole purpose is to present some concepts disclosed herein in a simplified form as a prelude to the more detailed description that is presented later.

The present example provides a way for identifying a person speaking during a video conference call, or a videotaped meeting. This may be done via a video nametag. A video nametag is a nametag device that may comprise a component to determine if a wearer is speaking, such as a microphone, accelerometer, or the like, and a component to signal a video camera or some other equipment that allows a conference system, recording system, or the like, to identify which participant is speaking.

Many of the attendant features may be more readily appreciated as the same becomes better understood by reference to the following detailed description considered in connection with the accompanying drawings.

### DESCRIPTION OF THE DRAWINGS

The present description may be better understood from the following detailed description read in light of the accompanying drawings, wherein:

FIG. 1 is a diagram of an exemplary video nametag.

FIG. 2 is a graph of exemplary output from an infrared (IR) emitter on a video nametag.

FIG. 3 is a flowchart of an exemplary method to decode IR emitter signals.

FIG. 4 is a block diagram of an example system in which video nametags are used.

FIG. 5 is a graph of a sample CMOS sensor light response.

FIG. 6 is an example panoramic image with video nametag names superimposed.

FIG. 7 is an example of a Common Intermediate Format (CIF) image with video nametag names superimposed.

FIG. 8 is a block diagram of an exemplary processing system.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a process and a system for identifying a speaking participant in a videoconference by using a video nametag. Although the present examples are described and illustrated herein as being implemented in videoconference systems, the system described is provided as an example and not a limitation. The present examples are suitable for application in a variety of different types of computing processors in various computer systems. At least one alternate implementation may use video nametags to index a video by the name of a person speaking.

The present example provides a way for a video conferencing system to display the name of a participant who is speaking on a screen at a remote location.

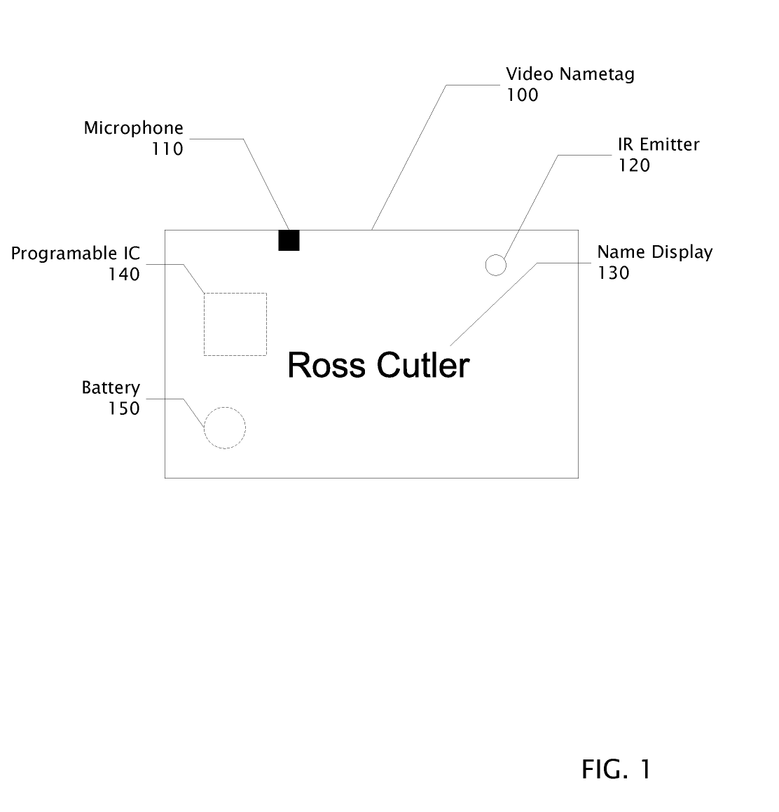

FIG. 1 is a block diagram of an example of a video nametag 100. It has a name display 130, indicating the person who will be identified as speaking when the wearer of the nametag is speaking. Microphone 110 is used to determine if a person wearing the nametag is speaking. In this example, the microphone has a figure-eight response pattern with the lowest response aimed orthogonal to the nametag and the major directivity axis vertical. This embodiment provides high sensitivity when the wearer speaks, and low sensitivity to other participants speaking nearby. An electret microphone may be used, as may micro-electric-mechanical (MEM) microphones. In alternate embodiments, a unidirectional microphone may be used, or an accelerometer may be used instead of or with a microphone. Any device that may determine if the wearer is speaking may be used. In at least one embodiment, a signal from the microphone may be transmitted to a video conferencing system wirelessly, using Bluetooth (R), or ultra wideband, for example. In at least one alternate implementation, a microphone may be connected a video conferencing system via a wire. Alternatively, any other methods of transferring a microphone signal may be used.

Infrared (IR) emitter 120 broadcasts a binary encoding indicating the identity of the wearer and a status indicating if the wearer is speaking (a “speaking status”). IR emissions may be invisible to meeting participants, but visible to a CCD or CMOS camera. In at least one implementation, the IR emitter frequency is close to the cutoff frequency for a cutoff filter in a receiving video camera, with a wavelength of approximately 650 nm. Other implementations may use different frequencies. Alternatively, any encoding or broadcasting methods capable of sending the desired information may be used.

Programmable integrated circuit (PIC) 140 processes the microphone signal and generates the IR emitter signals. A digital sound processor (DSP), a custom application-specific integrated circuit (ASIC), or the like may be used in alternative embodiments. Such a component may or may not be visible on the video nametag 100.

The name display 130 is a name printed on the video nametag 100. In another example, it may comprise a liquid crystal display (LCD), or any other means to identify the wearer. In an alternate embodiment, the name may not be displayed on the video nametag 100. In at least one embodiment, a person may be associated to a video nametag via a USB connection. In at least one alternate embodiment, a smart card and a smart card reader may be used to associate a person to a video nametag.

A battery 150 or other power source may be required to power the electronics on the video nametag 100. Such a power source may be a rechargeable or disposable battery, a solar cell, or any other source that can provide the required power. A power source may be visible, or may be hidden within or behind the video nametag 100.

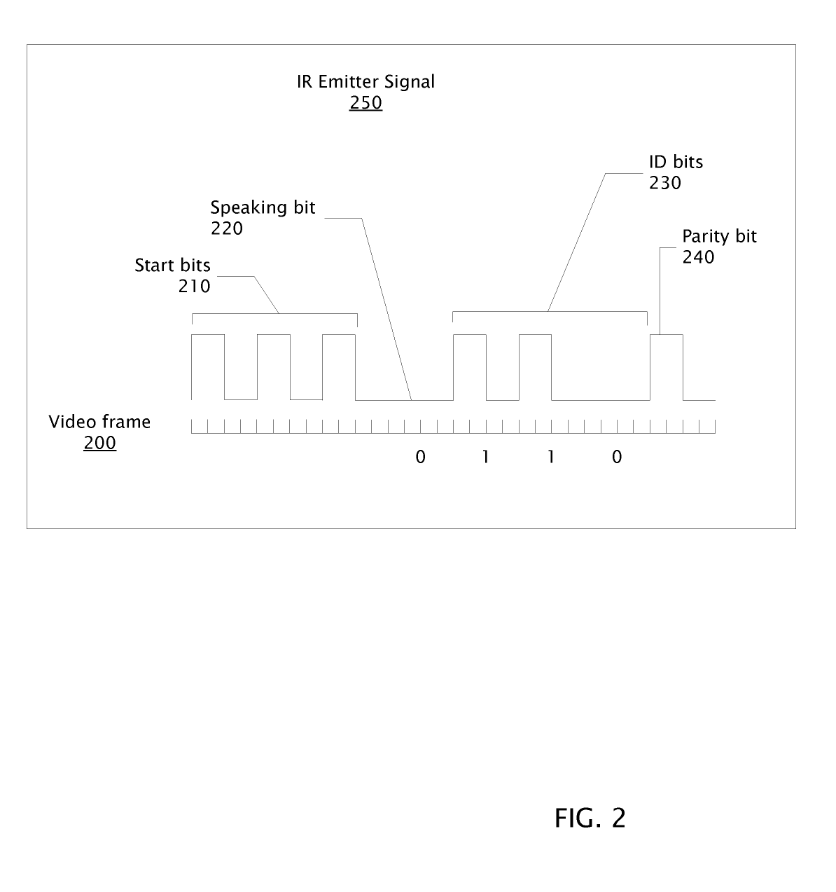

In the following discussion of FIG. 2, continuing reference will be made to elements and reference numerals shown in FIG. 1.

FIG. 2 is a of an example signal 250 that may be emitted by the IR emitter 120 on a video nametag 100. Video frame 200 is shown to identify timing of the signal bits displayed by the IR emitter 120. In this example, Start bits 210 give an indication that a message is about to start. Alternate implementations may have any number of start bits. A speaking bit 220 is 0, which in this example means the wearer of video nametag 100 is not speaking at this time. ID bits 230 is a set of bits used to identify the video nametag 100. In many instances, four bits (allowing for sixteen distinct identifications) would be sufficient for this function, but any number of bits sufficient to differentiate between the participants could be used.

Parity bit 240 provides error detection, so that the system can determine if it received a valid reading from the IR emitter. In one implementation, a parity bit may be set to make the total number of even bits in the message even. In an alternate implementation, a parity bit may make the total number of bits in the message odd. In yet another implementation, other forms of error detection or error detection and correction may be used; alternatively, no error detection or correction may be performed on the signal.

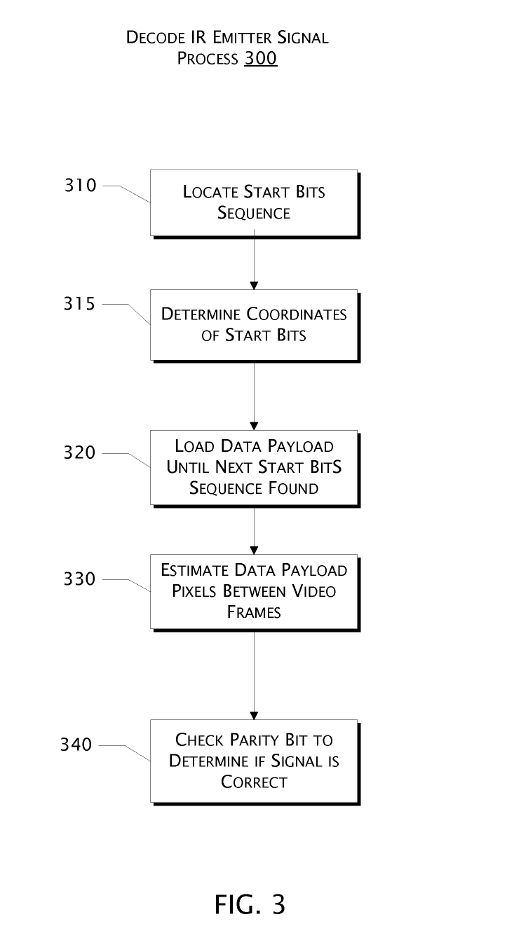

FIG. 3 is a flow chart of an example process 300 for decoding the IR emitter signal. At step 310, the video sequence is examined to find the start bits signal. At block 315, the x and y coordinates and which video frame the start bits are on is determined. Once the start bits have been located, the remaining data payload bits are loaded at step 320 until the next start bits signal is found. The data payload is linearly interpolated between video frames to correct for nametag motion during a frame duration; the value of the payload in step 330 is computed, and the parity bit is checked at step 340 to validate the data integrity.

This example is only one method for decoding the data from the video nametag. Other embodiments may use enhanced error correction, for example. In an alternate implementation, other forms of interpolation may be used instead of linear interpolation. Other methods of identifying the beginning and ending of the data payload may also be used. A method for decoding the signal from the video nametags may have more or fewer steps, and the steps may occur in a different order than that illustrated in this example.

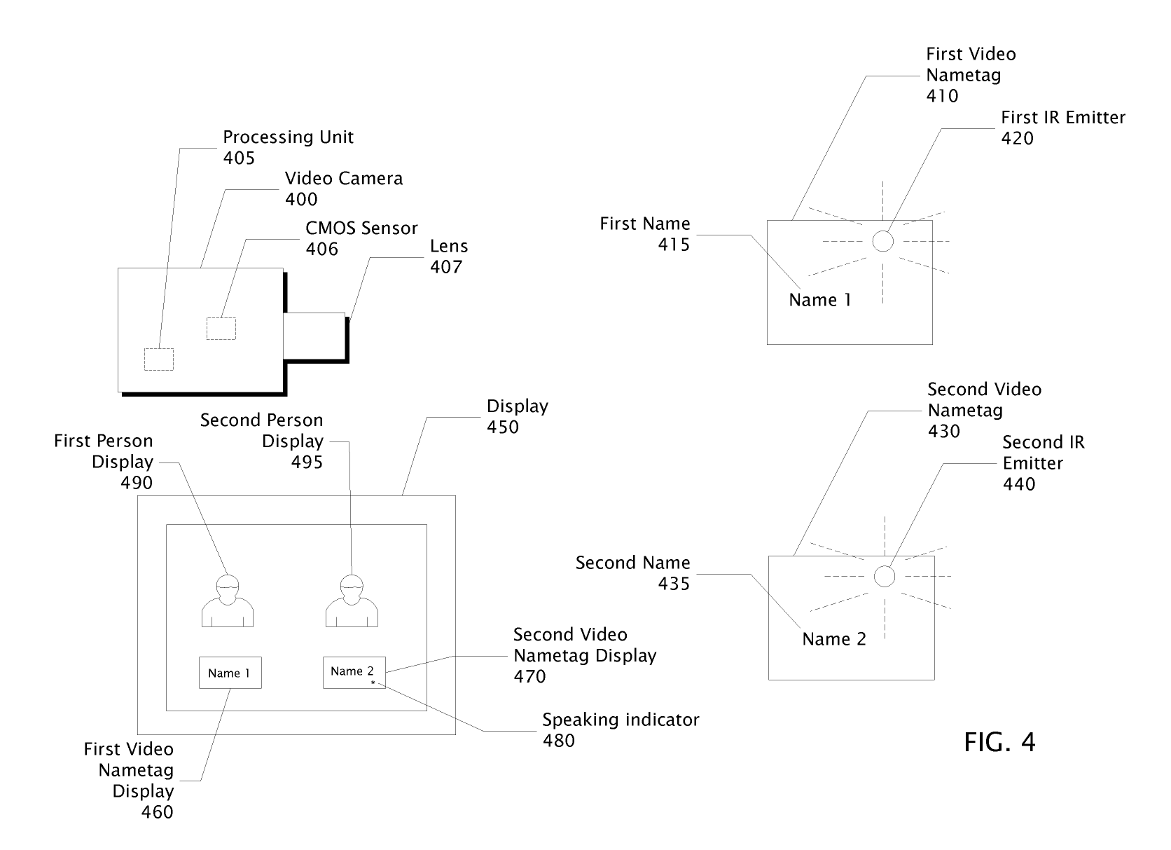

FIG. 4 is a block diagram of an example system using video nametags. First video nametag 410 comprises first IR emitter 420, and printed first name 415, “Name 1.” Second video nametag 430 comprises second IR emitter 440 and printed second name 435, “Name 2.” First IR emitter 420 and second IR emitter 440 each display a signal that video camera 400 can detect, but people in the room do not see. In this example, a first person (not shown) is wearing first video nametag 410, and a second person (not shown) is wearing second video nametag 430. Lens 407 focuses an image on CMOS sensor 406. Processing unit 405 in video camera 400 processes the images produced by CMOS sensor 406 and determines the appropriate nametag to display. The output from video camera 400 output is displayed on display 450. Display 450 is displaying first video nametag display 460 below first person display 490, and second video nametag display 470 below second person display 495. In this example video camera 400 has a CMOS sensor, but other sensors, such as CCD or the like may also be used instead of or in addition to a CMOS sensor. Processing unit 405 may be internal or external to a camera, or may be split into various components, with some processing done by the camera and other processing done in one or more other devices.

In this example, first person display 490 and second person display 495 are implemented as real-time video, however in alternate implementations, a similar display (not shown) may be delayed, the images may be static pictures, such as a photo, or there may be no picture associated with the participants. Second video nametag display 470 has a speaking indicator 480 to show that the second person is speaking. This indicator may be a character or other mark displayed on the nametag display 450, or it may be done in any other way to indicate a person is speaking, such as having the nametag display 450 flash, having the name change color, create or change a frame around the nametag display 450, provide a close-up picture of the person speaking, or the like. Alternatively, there may be no visual indicator; there may be indicators using sound or other ways to notify participants, or the participants may not be notified, such as where the video nametag is used for testing other speaker-recognition methods and devices, or where a meeting is being recorded, being processed by a computer, or the like.

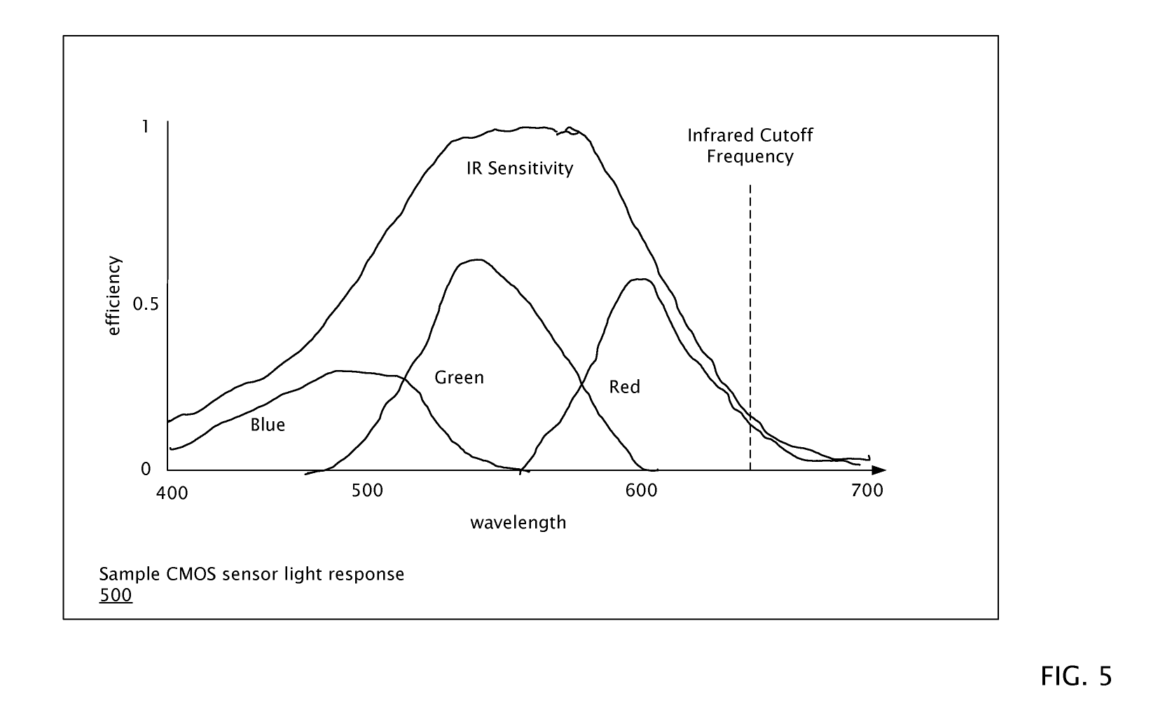

FIG. 5 is a graph of a sample CMOS sensor light response 500. Infrared (IR) emissions may be invisible to meeting participants, but visible to a CCD or CMOS camera. In the graph 500 shown, efficiency of the CMOS sensor is charted against light spectrum wavelengths. In at least one implementation, the IR emitter wavelength is close to the cutoff wavelength for a cutoff filter in a receiving video camera, with a wavelength of approximately 650 nm, shown on the graph with a dotted vertical line. Other implementations may use different frequencies, and other sensors may have different frequency responses than that example shown.

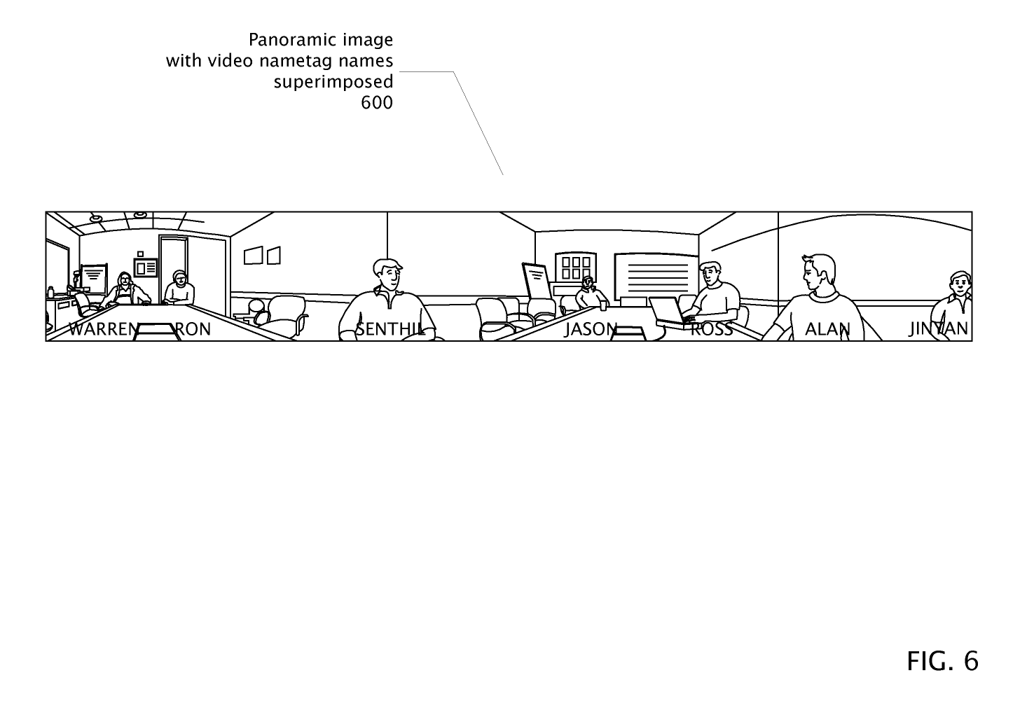

FIG. 6 is a drawing of an example panoramic image 600 with superimposed video nametag names. On this display, people are depicted participating at one site in a video conference. However, in one or more alternate embodiments, the image 600 may be shown at one or more remote sites. Below each of the people shown on the display, a name is displayed based on information coming from video nametags.

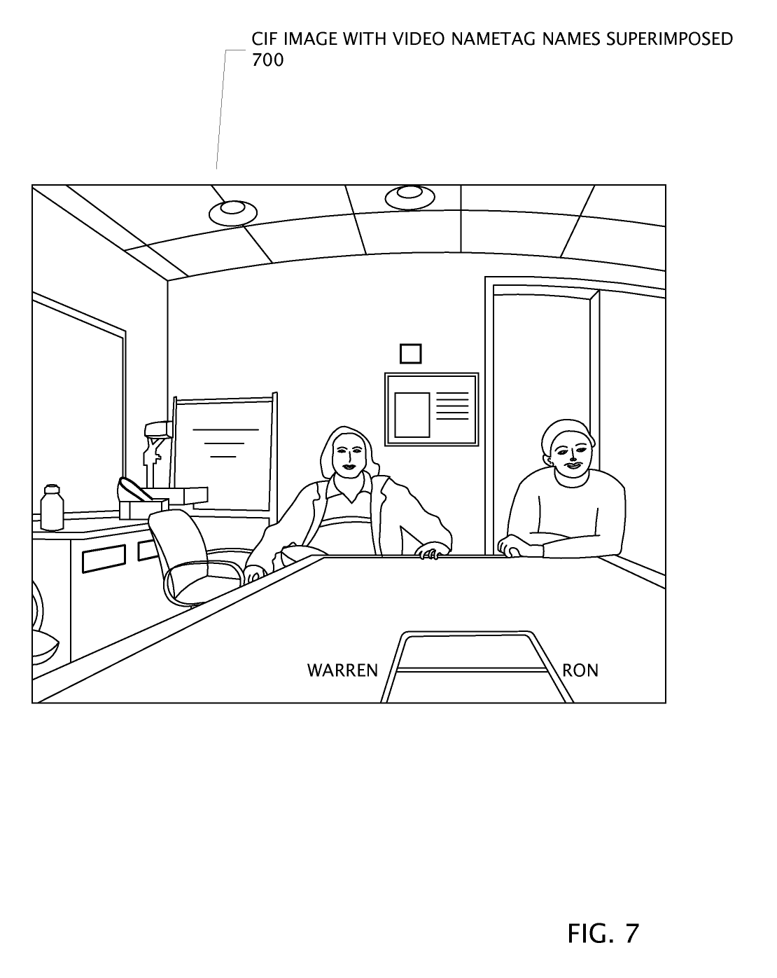

FIG. 7 is a drawing of an example Common Intermediate Format (CIF) image 700 with superimposed video nametag names. The image 700, which may be a subsection of a larger image (not shown) showing an entire meeting room, may be shown if the videoconferencing system determines that one of the people shown is speaking.

For example, if a person in the image 700 (“Warren” for example), is speaking, a speaker detection system included in the videoconferencing system may automatically identify “Warren” as the speaker. The videoconferencing system may then automatically isolate the image 700 from a larger image (not shown) that shows every person in the meeting room (similar to the image 600 shown in FIG. 6). The image 700 may then be shown either alone or together with the larger image to give a better view of the speaker.

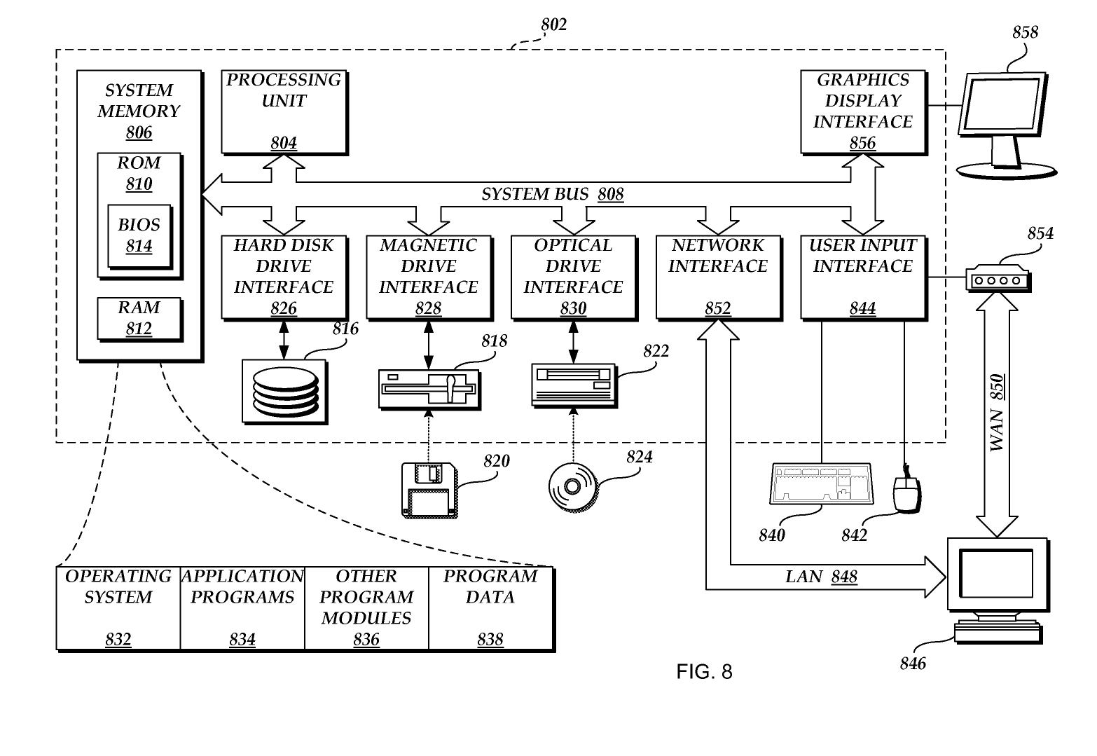

FIG. 8 illustrates an example of a suitable computing system environment or architecture in which computing subsystems may provide processing functionality. The computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

The method or system disclosed herein is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The method or system may be described in the general context of computer-executable instructions, such as program modules, being executed by a computer. Generally, program modules include routines, programs, objects, components, data structures, etc. that perform particular tasks or implement particular abstract data types. The method or system may also be practiced in distributed computing environments where tasks are performed by remote processing devices that are linked through a communications network. In a distributed computing environment, program modules may be located in both local and remote computer storage media including memory storage devices.

With reference to FIG. 8, an exemplary system for implementing the method or system includes a general purpose computing device in the form of a computer 802. Components of computer 802 may include, but are not limited to, a processing unit 804, a system memory 806, and a system bus 808 that couples various system components including the system memory to the processing unit 804. The system bus 808 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 802 typically includes a variety of computer readable media. Computer readable media can be any available media that can be accessed by computer 802 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 802. Combinations of the any of the above should also be included within the scope of computer readable storage media.

The system memory 806 includes computer storage media in the form of volatile and/or nonvolatile memory such as read only memory (ROM) 810 and random access memory (RAM) 812. A basic input/output system 814 (BIOS), containing the basic routines that help to transfer information between elements within computer 802, such as during start-up, is typically stored in ROM 810. RAM 812 typically contains data and/or program modules that are immediately accessible to and/or presently being operated on by processing unit 804. By way of example, and not limitation, FIG. 8 illustrates operating system 832, application programs 834, other program modules 836, and program data 838.

The computer 802 may also include other removable/non-removable, volatile/nonvolatile computer storage media. By way of example only, FIG. 8 illustrates a hard disk drive 816 that reads from or writes to non-removable, nonvolatile magnetic media, a magnetic disk drive 818 that reads from or writes to a removable, nonvolatile magnetic disk 820, and an optical disk drive 822 that reads from or writes to a removable, nonvolatile optical disk 824 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 816 is typically connected to the system bus 808 through a non-removable memory interface such as interface 826, and magnetic disk drive 818 and optical disk drive 822 are typically connected to the system bus 808 by a removable memory interface, such as interface 828 or 830.

The drives and their associated computer storage media discussed above and illustrated in FIG. 8, provide storage of computer readable instructions, data structures, program modules and other data for the computer 802. In FIG. 8, for example, hard disk drive 816 is illustrated as storing operating system 832, application programs 834, other program modules 836, and program data 838. Note that these components can either be the same as or different from additional operating systems, application programs, other program modules, and program data, for example, different copies of any of the elements. A user may enter commands and information into the computer 802 through input devices such as a keyboard 840 and pointing device 842, commonly referred to as a mouse, trackball or touch pad. Other input devices (not shown) may include a microphone, joystick, game pad, pen, scanner, or the like. These and other input devices are often connected to the processing unit 804 through a user input interface 844 that is coupled to the system bus, but may be connected by other interface and bus structures, such as a parallel port, game port or a universal serial bus (USB). A monitor 858 or other type of display device is also connected to the system bus 808 via an interface, such as a video interface or graphics display interface 856. In addition to the monitor 858, computers may also include other peripheral output devices such as speakers (not shown) and printer (not shown), which may be connected through an output peripheral interface (not shown).

The computer 802 may operate in a networked environment using logical connections to one or more remote computers, such as a remote computer. The remote computer may be a personal computer, a server, a router, a network PC, a peer device or other common network node, and typically includes many or all of the elements described above relative to the computer 802. The logical connections depicted in FIG. 8 include a local area network (LAN) 848 and a wide area network (WAN) 850, but may also include other networks. Such networking environments are commonplace in offices, enterprise-wide computer networks, intranets and the Internet.

When used in a LAN networking environment, the computer 802 is connected to the LAN 848 through a network interface or adapter 852. When used in a WAN networking environment, the computer 802 typically includes a modem 854 or other means for establishing communications over the WAN 850, such as the Internet. The modem 854, which may be internal or external, may be connected to the system bus 808 via the user input interface 844, or other appropriate mechanism. In a networked environment, program modules depicted relative to the computer 802, or portions thereof, may be stored in the remote memory storage device. By way of example, and not limitation, remote application programs may reside on a memory device. It will be appreciated that the network connections shown are exemplary and other means of establishing a communications link between the computers may be used.

1. A video nametag, comprising:
one or more sensors configured to detect speech from a person associated with the video nametag and to provide an output corresponding thereto;
one or more processing components configured to determine the speaking status of the person associated with the video nametag based on the output of the one or more sensors; and
one or more signaling devices configured to send a signal indicating the speaker status of the person associated with the video nametag.

2. The video nametag of claim 1 wherein at least one of the one or more sensors is a microphone.

3. The video nametag of claim 2 further comprising a wireless transmitter to transmit the output of the one or more microphones.

4. The video nametag of claim 1 wherein at least one of the one or more sensors is an accelerometer.

5. The video nametag of claim 1 wherein at least one of the one or more signaling devices is an infra-red emitter.

6. The video nametag of claim 1 wherein the person is associated with the video nametag via a device coupled to the video nametag via a universal serial bus connection.

7. The video nametag of claim 1 wherein the person is associated with the video nametag using a smart card reader coupled to the video nametag.

8. A system comprising:
One or more video nametags;
at least one receiving device which can receive the signals sent by the video nametag.

9. The system of claim 8 wherein at least one of the receiving devices is a video camera.

10. The system of claim 8 further comprising a display which indicates the speaking status determined by the one or more nametags associated with an image of one or more wearers of the one or more nametags.

11. The system of claim 10 wherein the image comprises a static picture.

12. The system of claim 10 wherein the image comprises a video in real-time.

13. The system of claim 10 wherein the image comprises a recorded video being played.

14. The system of claim 8 wherein at least one of the video nametags transmits an output of at least one microphone to at least one of the receiving devices via a wireless signal.

15. The system of claim 8 wherein at least one of the video nametags transmits an output of at least one microphone to at least one of the receiving devices via wire.

16. A method comprising:
displaying an image of a person on a display;
receiving a signal from a video nametag associated with the person;
determining from the signal whether the person is speaking;
if the person is determined to be speaking, providing an indication on the display that the person is speaking.

17. The method of claim 16 wherein the image of the person further comprises a real-time video.

18. The method of claim 16 wherein the image of the person further comprises a static image.

19. The method of claim 16 wherein the image of the person further comprises a prerecorded video.

20. The method of claim 16 wherein the indication further comprises a bold font display of a name for the person.
